(19) United States
(12) Patent Application Publication
(10) Pub. No.: US 2011/0283540 A1
(43) Pub. Date: Nov. 24, 2011

(54) BACK SHAVING DEVICE

(76) Inventor: Edward Brian Wetteroff, St. Louis, MO (US)

(21) Appl. No.: 12/784,131

(22) Filed: May 20, 2010

(51) Int. Cl. B26B 21/52; B26B 21/14

(52) U.S. Cl. 30/47; 30/526; 132/212

(57) ABSTRACT

This invention presents a shaving device. The shaving device has a razor mount member. The shaving device further has a first flexible extension extending from a first side of the razor mount member and a second flexible extension extending from a second side of the razor mount member. The first and second flexible extensions can be straps.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention relates generally to shavers, and more particularly to a back shaving device.

2. Description of Related Art

Shaving devices have been used for shaving body hair. However, none of them are specifically suitable for back shaving.

### SUMMARY OF THE INVENTION

The present invention presents a shaving device. The shaving device has a razor mount member. The shaving device further has a first flexible extension extending from a first side of the razor mount member and a second flexible extension member extending from a second side of the razor mount member.

In an embodiment, the first extension can be a first strap, and the second flexible extension can be a second strap. Alternatively, the first extension can be a first portion of a strap, and the second extension can be a second portion of the same strap.

Preferably, each of the first and second flexible extensions can have a first loop portion engaged with the razor mount member. The shaving device can further have a first fastener for forming the first loop portion of the first flexible extension, and a second fastener for forming the first loop portion of the second flexible extension. Preferably, the first and second fasteners can be adjustable fasteners. Preferably, the adjustable fasteners can be adjustable strap holders. Additionally, each of the first and second flexible extensions can also have a second loop portion.

In a preferred embodiment, the razor mount member can have a first extension receiver for receiving the first flexible extension, and a second extension receiver for receiving the second flexible extension. The first and second extension receivers can be through-holes.

In a preferred embodiment, the razor mount member can have a razor adapter receiving portion. Preferably, the razor adapter receiving portion can be a channel. A razor adapter can be mounted in the razor adapter receiving portion. The razor mount member can have a lock-assisting portion for engaging with the razor adapter. A razor head can be attached onto the razor adapter.

The present invention also presents a shaving device comprising a razor mount member having a first extension receiver for receiving a first flexible extension, and a second extension receiver for receiving a second flexible extension.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 shows a shaving device according to the present invention.

FIG. 2 is a perspective view of a razor mount member of the shaving device of FIG. 1.

FIG. 3 is a front view of the razor mount member of FIG. 2.

FIG. 4 is a bottom view of the razor mount member of FIG. 2.

FIG. 5 is a side view of the razor mount member of FIG. 2.

FIG. 6 shows a shaving device according to the present invention where a single strap is employed.

FIG. 7 shows a variation of the shaving device of FIG. 6.

### DETAILED DESCRIPTION OF THE INVENTION

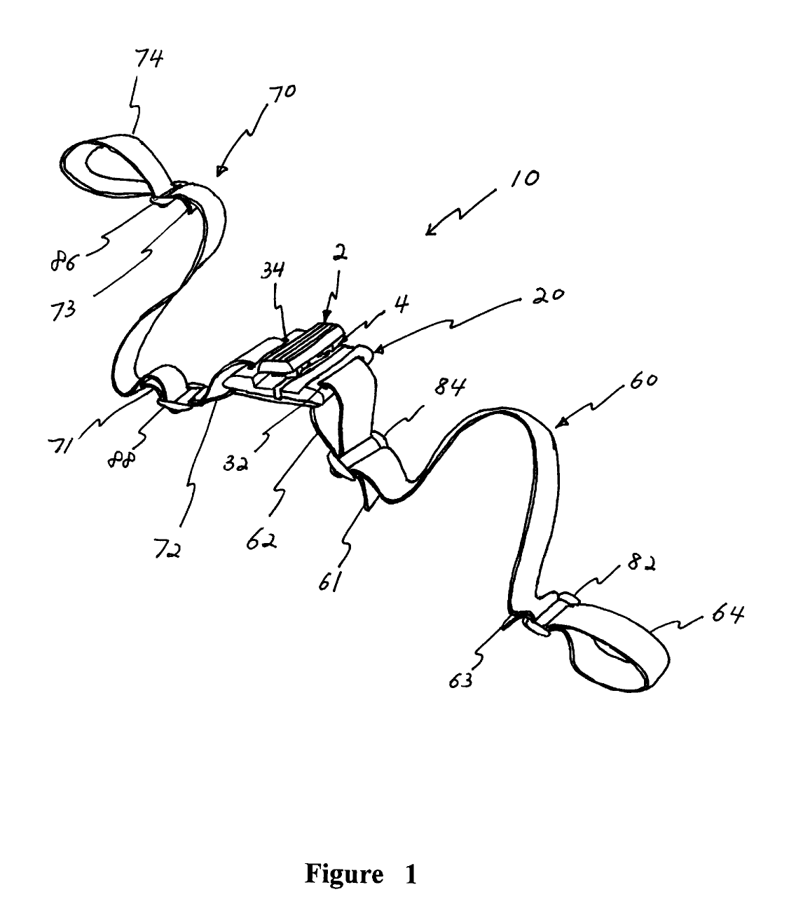

Shown in FIG. 1 is a shaving device 10 according to an embodiment of the present invention. The shaving device 10 has a razor mount member 20 on which a razor adapter 4 is mounted. Attached on the razor adapter 4 is a razor head 2. The shaving device 10 also has a first flexible extension 60 and a second flexible extension 70, attached to and extending from each side of the razor mount member 20. In the illustrated embodiment, the first and second flexible extensions 60, 70 are straps. In use, a user grips the first and second flexible extensions 60, 70 and orients the razor head 2 to contact the back of his/her body. By moving the first and second flexible extensions 60, 70, the user can move the razor head 2 across the back. The razor head 2 may be commercially available ones.

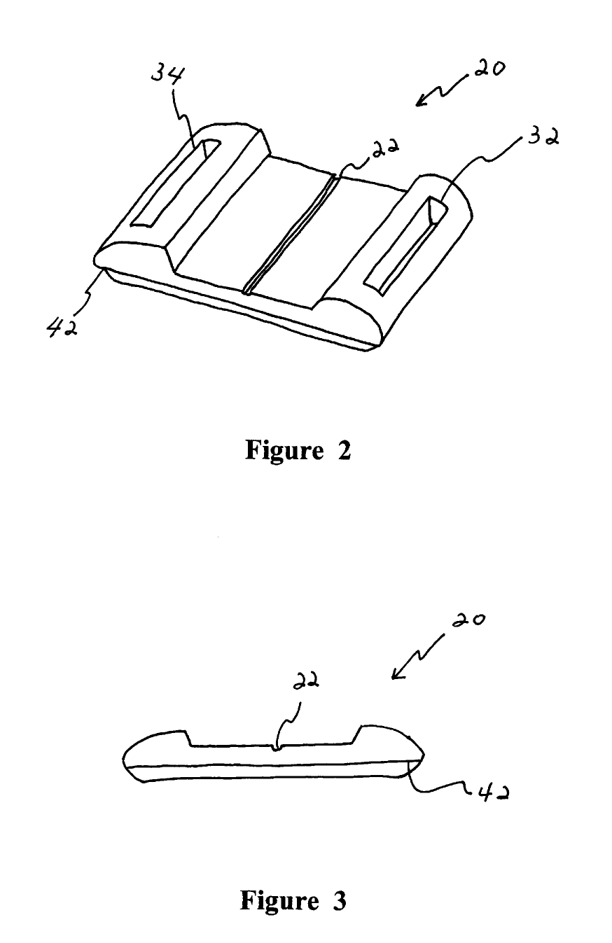

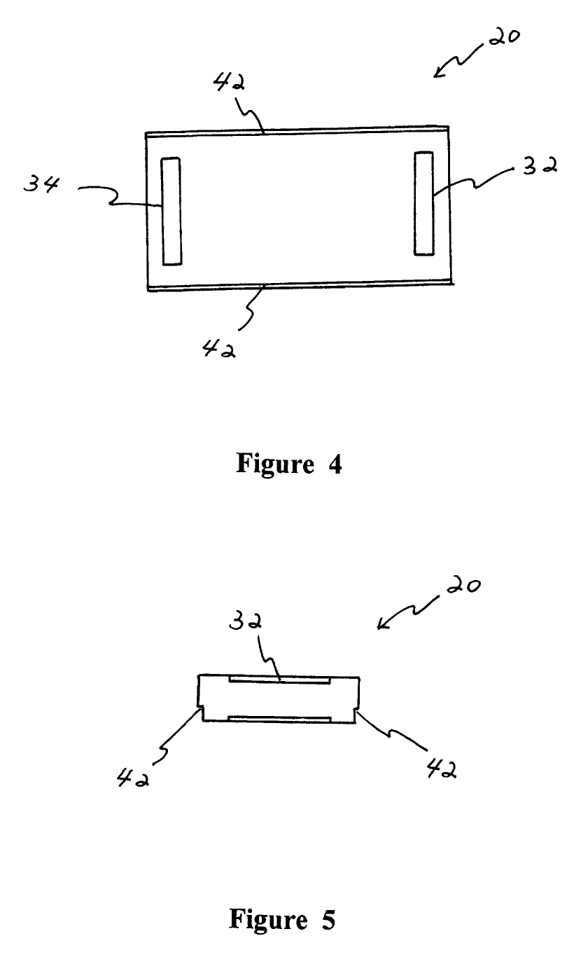

FIGS. 2-5 show the razor mount member 20. In the illustrated embodiment, the razor mount member 20 is in the form of a block. The razor mount member 20 has a razor adapter receiver 22 for receiving the razor adapter 4. In the illustrated embodiment, the razor adapter receiver 22 is in the form of a channel formed in the top surface of the razor mount member 20.

The razor mount member 20 also has a first extension receiver 32 for receiving the first flexible extension 60 and a second extension receiver 34 for receiving the second flexible extension 70. In the illustrated embodiment, the first and second extension receivers 32, 34 are in the form of through-holes.

The razor mount member 20 can have lock-assisting portions 42 that can be engaged with portions of the razor adapter 4 so as to assist the locking of the razor adapter 4 to the razor mount member 20. In the illustrated embodiment, the lock-assisting portion 42 is step portions formed in the front surface and rear surface of the razor mount member 20 that can be engaged with, for example, hook-portions of the razor mount member 20. Other lock-assisting features may be employed.

In FIG. 1, the first flexible extension 60 has a first end 61 and a second end 63. The first flexible extension 60 is connected to the razor mount member 20 by passing the first end 61 through the first extension receiver 32 of the razor mount member 20 and then fastening the first end 61 of the first flexible extension 60 to the other portion of the first flexible extension 60 so as to form a first loop portion 62 of the first flexible extension 60 engaged with the first extension receiver 32 of the razor mount member 20. The fastening of the first end 61 of the first flexible extension 60 to the other portion of the first flexible extension 60 can be accomplished by using a first fastener 84. In the illustrated embodiment, the first fastener 84 is an adjustable strap holder that can removeably fasten the first end 61 of the first flexible extension 60 to the other portion of first flexible extension 60.

Similarly, the second flexible extension 70 has a first end 71 and a second end 73. The second flexible extension 70 is connected to the razor mount member 20 by passing the first end 71 through the second extension receiver 34 of the razor mount member 20 and then fastening the first end 71 of the second flexible extension 70 to the other portion of the second flexible extension 70 so as to form a first loop portion 72 of the second flexible extension 70 engaged with the second extension receiver 34 of the razor mount member 20. The fastening of the first end 71 of the second flexible extension 70 to the other portion of the second flexible extension 70 can be accomplished by using a second fastener 88. The second fastener 88 can be identical to the first fastener 84.

When the first and second fasteners 84, 88 are adjustable strap holders as illustrated, the user can remove the first and second flexible extensions 60, 70 from the razor mount member 20 by sliding the first ends 61, 71 out of the first and second fasteners 84, 88, whereby breaking the first loop portions 62, 72. In addition, adjustable strap holders can also allow the user to adjust the overall lengths of the first and second flexible extensions 60, 70.

The first flexible extension 60 can also have a second loop portion 64 formed by fastening the second end 63 of the first flexible extension 60 to the other portion of the first flexible extension 60 using a third fastener 82. Likewise, the second flexible extension 70 can also have a second loop portion 74 formed by fastening the second end 73 of the second flexible extension 70 to the other portion of the second flexible extension 70 using a fourth fastener 86. The second loop portions 64, 74 can assist in the gripping of the first and second flexible extensions 60, 70 by the user. The third and fourth fasteners 82, 86 may also be adjustable strap holders as illustrated so as to allow the user to further adjust the overall lengths of the first and second flexible extensions 60, 70.

The shaving device 10 according to the present invention may have two razor heads 2, preferably disposed in opposite orientations to each other so that the shaving device 10 can shave the back in both directions.

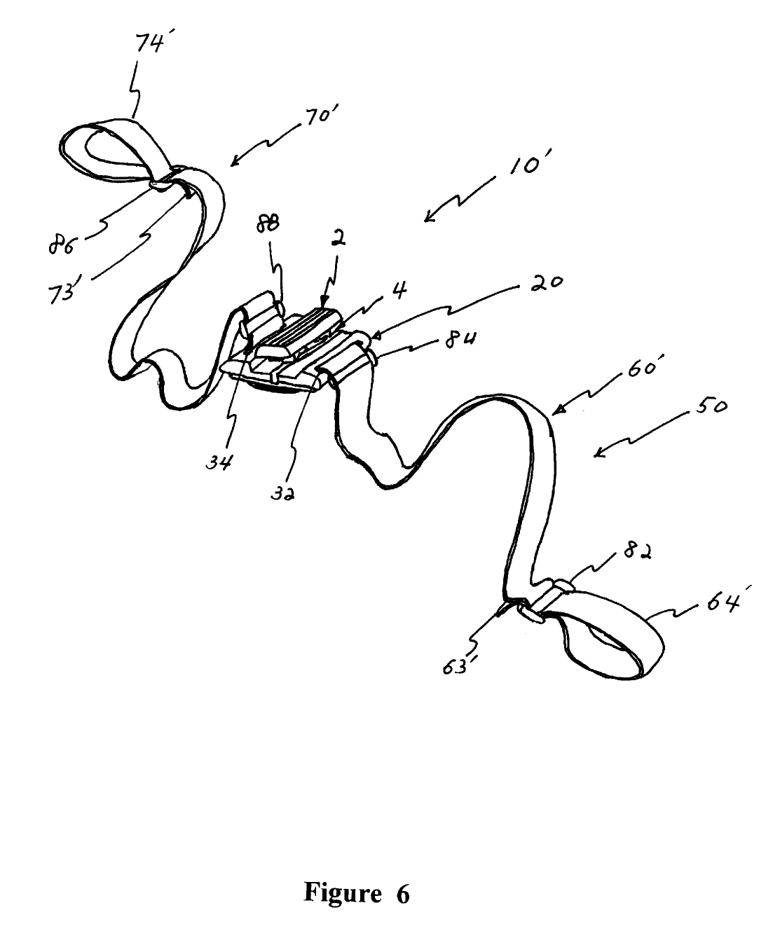

Shown in FIG. 6 is a variant of the present invention. The shaving device 10′ shown in FIG. 6 is identical with the shaving device 10 shown in FIG. 1 except that the shaving device 10′ in FIG. 6 employs a single strap 50 instead of two separate straps 60, 70 as illustrated in FIG. 1. The strap 50 is engaged with the razor mount member 20 by passing through the first and second extension receivers 32, 34 of the razor mount member 20 such that the strap 50 extends from both sides of the razor mount member 20 as shown in FIG. 6. Accordingly, a first portion 60′ of the strap 50 extends from the first extension receiver 32 of the razor mount member 20, and a second portion 70′ of the strap 50 extends from the second extension receiver 34 of the razor mount member 20.

The first and second fasteners 84, 88 can be attached respectively to the first and second portions 60′, 70′ of the strap 50 adjacent to the razor mount member 20 so as to help restrict a sliding between the strap 50 and the razor mount member 20 during the use of the shaving device 10′. The first and second fasteners 84, 88 may be adjustable strap holders.

The strap 50 has a first end 63′ in the first portion 60′ and a second end 73′ in the second portion 70′. The first portion 60′ of the strap 50 can have a loop 64′ formed by fastening the first end 63′ to the other portion of the first portion 60′ of the strap 50 using a third fastener 82. Likewise, the second portion 70′ of the strap 50 can also have a loop 74 formed by fastening the second end 73′ of the second portion 70′ of the strap 50 to the other portion of the second portion 70′ using a fourth fastener 86. The loops 64, 74 can assist in the gripping of the first and second portions 60′, 70′ of the strap 50 by the user. The third and fourth fasteners 82, 86 may also be adjustable strap holders as illustrated so as to allow the user to further adjust the overall lengths of the first and second portions 60′, 70′ of the strap 50.

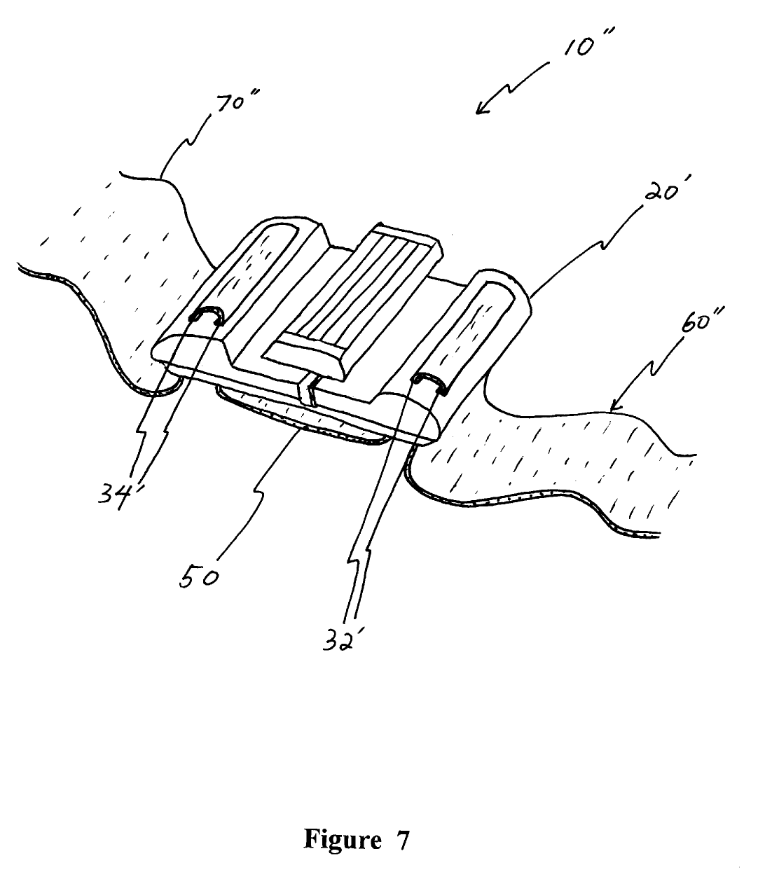

Shown in FIG. 7 is a further variant of the present invention. The shaving device 10″ shown in FIG. 7 is identical with the shaving device 10′ shown in FIG. 6 except that the shaving device 10″ employs a razor mount member 20′ having first and second extension receivers 32′, 34′ which are slightly different the first and second extension receivers 32, 34 shown in FIGS. 1, 2 and 6. The first extension receiver 32′ is different from the first extension receiver 32 in that the first extension receiver 32′ is comprised of a pair of adjacent through-holes instead of a single through hole. The second extension receiver 34′ is different from the second extension receiver 34 in that the second extension receiver 34′ is comprised of a pair of adjacent through-holes instead of a single through-hole.

The strap 50 is engaged with the razor mount member 20′ by passing through the pair of through-holes of the first extension receiver 32′ and then through the pair of through-holes of the second extension receivers 32′, 34′ such that the strap 50 extends from both sides of the razor mount member 20 as shown in FIG. 7. Accordingly, a first portion 60″ of the strap 50 extends from the first extension receiver 32′ of the razor mount member 20′, and a second portion 70″ of the strap 50 extends from the second extension receiver 34′ of the razor mount member 20′. The first and second fasteners 84, 88 as shown in FIG. 6 may be omitted in this embodiment because the engagement of the strip 50 and the pairs of through-holes of the first and second extension receivers 32′, 34′ can sufficiently restrict a sliding between the strap 50 and the razor mount member 20′ during the use of the shaving device 10″.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A shaving device comprising:
a razor mount member;
a first flexible extension extending from a first side of said razor mount member; and
a second flexible extension extending from a second side of said razor mount member.

2. The shaving device of claim 1, wherein said first extension comprises a first strap, and said second flexible extension comprises a second strap.

3. The shaving device of claim 1, wherein said first extension comprises a first portion of a strap, and said second extension comprises a second portion of the same strap.

4. The shaving device of claim 1, wherein each of said first and second flexible extensions has a first loop portion engaged with said razor mount member.

5. The shaving device of claim 4, wherein each of said first and second flexible extensions has a second loop portion.

6. The shaving device of claim 4, further comprising a first fastener for forming said first loop portion of said first flexible extension, and a second fastener for forming said first loop portion of said second flexible extension.

7. The shaving device of claim 6, wherein said first and second fasteners comprise adjustable fasteners.

8. The shaving device of claim 6, wherein said adjustable fasteners comprise adjustable strap holders.

9. The shaving device of claim 1, wherein said razor mount member has a first extension receiver for receiving said first flexible extension, and a second extension receiver for receiving said second flexible extension.

10. The shaving device of claim 9, wherein said first and second extension receivers comprise through-holes.

11. The shaving device of claim 1, wherein said razor mount member has a razor adapter receiving portion.

12. The shaving device of claim 11, wherein said razor adapter receiving portion comprises a channel.

13. The shaving device of claim 11, further comprising a razor adapter mounted in said razor adapter receiving portion.

14. The shaving device of claim 13, wherein said razor mount member has a lock-assisting portion for engaging with said razor adapter.

15. The shaving device of claim 13, further comprising a razor head attached onto said razor adapter.

16. A shaving device comprising:
a razor mount member;
wherein said razor mount member has a first extension receiver for receiving a first flexible extension, and a second extension receiver for receiving a second flexible extension.

17. The shaving device of claim 16, wherein said first and second extension receivers comprise through-holes.

18. The shaving device of claim 16, wherein said razor mount member has a razor adapter receiving portion for receiving a razor adapter.

19. The shaving device of claim 18, wherein said razor adapter receiving portion comprises a channel.

20. The shaving device of claim 18, wherein said razor mount member has a lock-assisting portion for engaging with the razor adapter.
